(19) United States
(12) Patent Application Publication
(10) Pub. No.: US 2026/0329964 A1
(43) Pub. Date: Oct. 22, 2026

(54) MULTI-TENANT TRAINING AND INFERENCE FOR FINE-TUNED ARTIFICIAL INTELLIGENCE (AI) MODELS

(71) Applicant: ADVANCED MICRO DEVICES, INC., Santa Clara, CA (US)

(72) Inventors: Bradford Michael Beckmann, Kirkland, WA (US); Kishore Punniyamurthy, Austin, TX (US); Rohit Sangameswara Dwivedula, Austin, TX (US)

(21) Appl. No.: 19/180,900

(22) Filed: Apr. 16, 2025

(51) Int. Cl. G06F 17/16; G06N 20/00

(52) U.S. Cl. CPC G06F 17/16; G06N 20/00

(57) ABSTRACT

A processing system includes parallel processors configured to perform matrix multiplications on portions of a base matrix of a generative artificial intelligence (AI) model and corresponding portions of an input matrix to form portions of a first matrix. The processing system also includes a switch configured to receive a copy of each portion of the input matrix and each portion of the first matrix from the parallel processors, perform matrix multiplications of a subset of adapter matrices and the portions of the input matrix to form a second matrix, combine the portions of the first matrix and the second matrix to form a third matrix, and distribute copies of the third matrix to the parallel processors. The switch includes memory and processing resources such as one or more compute units.

### BACKGROUND

Machine learning (ML) models, which include artificial intelligence (AI) models and techniques, operate on numerical representations of data such as text, audio, and images. A typical numerical representation is an embedding such as a vector embedding that encodes features of the data in a series (or vector) of numerical values. An ML model can be trained to transform the numerical representation of the input data into one or more output values such as a value indicating the identity of a feature in the data, a classification of the feature, or a value that is predicted based upon the input data. The nodes of an ML model are connected so that the output of nodes in one layer becomes the input to nodes in a subsequent layer. As data is passed from one node to the next, the data is multiplied by a weight associated with the connection between the two nodes. The weight therefore represents the strength of the connection between the two nodes. Nodes combine the weighted inputs, typically as a linear combination, to determine a value that is provided to an activation function that determines whether the node should “activate.” Examples of activation functions include a sigmoid function, a rectified linear unit (ReLU) function, a softmax function, and a hyperbolic tangent function. One class of ML models, generative AI models, generate new data (such as text, images, or videos) based on underlying patterns and structures that are “learned” from the training data.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that offloads selected portions of operations used to train an ML model or perform inference using the ML model to a switch that includes memory and processing resources, according to some embodiments.

FIG. 2 illustrates a generative AI model formed of a series of layers, according to some embodiments.

FIG. 3 illustrates a processing system that supports multi-tenant training and inference for fine-tuned generative AI models, according to some embodiments.

FIG. 4 illustrates a processing system that supports multi-tenant training and inference for fine-tuned generative AI models by offloading processing of adapter matrices to a “smart” switch, according to some embodiments.

FIG. 5 illustrates a processing system that supports multi-tenant training and inference for fine-tuned generative AI models by partially offloading processing of adapter matrices to a switch, according to some embodiments.

### DETAILED DESCRIPTION

Relatively small generative AI models are represented by, for example, a few billion parameters and can run on a smart phone, larger models having tens of billions of parameters can run on laptop or desktop computers, and the largest models (such as large language models, LLMs) include, for example, hundreds of billions of parameters and typically run on arrays of parallel processors such as graphics processing units (GPUs). Although large generative AI models, such as LLMs, generally are trained on massive data sets (e.g., data obtained widely from the Internet) to perform complex tasks such as holding realistic conversations or writing computer code based on prompts, they often lack domain-specific knowledge or knowledge of an individual context. Fine-tuning the hundreds of billions of parameters in a large generative AI model to reflect domain-specific or individual data can be prohibitively expensive in terms of memory, computing power, and bandwidth. Techniques such as low-rank adaptation (LoRA) are therefore used to create “adapters” that are trained on domain-specific or individual data. The adapters are combined with a general-purpose generative AI model to produce a domain-specific or individual generative AI model. A single generative AI model can therefore support multiple models tailored to different contexts using different adapters in a multi-tenant configuration. However, the number of models supported by a multi-tenant system is typically limited by the capacity of high bandwidth memory (HBM) in the GPUs that train or perform inference using the model. The adapters can be stored in memory at the central processing unit (CPU) and loaded into the GPU HBM as needed, but contention for the limited bandwidth between the CPU and GPU can produce bottlenecks during training or inference. Communication between the GPUs is mediated by switches that are relatively “dumb” and do not include memory or significant processing capability.

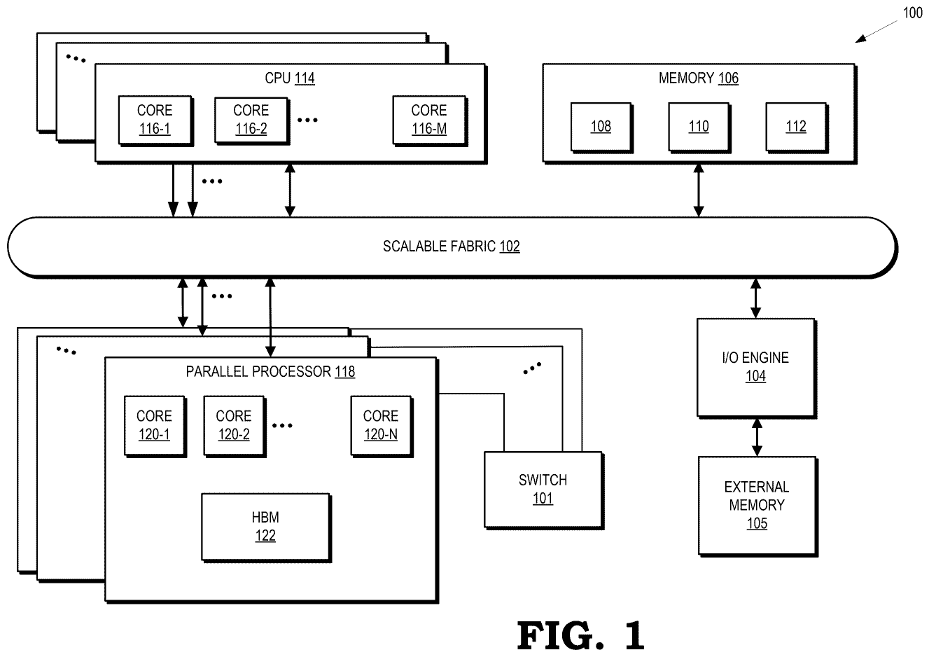

FIGS. 1-5 illustrate systems, apparatuses, and methods that leverage the resources of a hardware-based switch that interconnects an array of parallel processors (such as GPUs) that train or perform inference on the generative AI model. The switch includes memory and processing resources, which distinguishes the switch from conventional switches that mediate communication between processors such as the GPUs that perform training or inference on ML models such as generative AI models. Offloading a portion of the training or inference operations, such as matrix multiplications, to the relatively “smart” switch reduces or mitigates constraints imposed by trade-offs between the memory, computing, and bandwidth requirements of a generative AI model.

In some embodiments, a plurality of parallel processors performs operations involving subsets of a base matrix (W) of the generative AI model and corresponding subsets of an input matrix (x). In some embodiments, the parallel processors perform matrix multiplications of shards of the base matrix (Wᵢ) and the input matrix (xᵢ), as well as providing copies of the shards of the input matrix (xᵢ) to the switch. Memory associated with the switch stores information representing adapter matrices that fine-tune the base matrix (W). The switch performs matrix multiplications of a subset of the adapter matrices and the input matrix to form a second matrix. The adapter matrices include a first (A) adapter matrix and a second (B) adapter matrix. Depending on the size of the memory associated with the switch, the available processing resources, or a combination thereof, the subset of adapter matrices can include both the first and second adapter matrices or only the second adapter matrix, in which case the plurality of parallel processors perform matrix multiplications of the input matrix (x) and the first adapter matrix (A). The parallel processors and the switch can perform their operations concurrently or in parallel. The parallel processors provide a first matrix (xW) representing results of the operations involving the base matrix to the switch. For example, each parallel processor can provide a first submatrix (xᵢWᵢ) representing results of operations performed on a shard of the base matrix to the switch. If the plurality of parallel processors performed matrix multiplication of the input matrix and the first adapter matrix, the results (xᵢAᵢ) of this matrix multiplication are also provided to the switch. The switch then forms an output matrix (xW+xAB) by combining the first matrix (xW) with a second matrix (xAB) representing the operations involving the adapter matrices. The output matrix is distributed to the plurality of parallel processors.

FIG. 1 is a block diagram of a processing system 100 that offloads selected portions of operations used to train an ML model or perform inference using the ML model to a switch 101 that includes memory and processing resources, according to some embodiments. The processing system 100 includes a scalable fabric 102 implemented with circuitry that supports communication between entities implemented in the processing system 100. The scalable fabric 102 can include a control fabric for conveying control signals and a data fabric for conveying data between entities in the processing system 100. Some implementations of the processing system 100 include other buses, bridges, switches, routers, and the like, which are not shown in FIG. 1 in the interest of clarity. An input/output (I/O) engine 104 is implemented with circuitry that handles input or output operations associated with an external memory 105, as well as other elements of the processing system 100 such as keyboards, mice, printers, displays, and the like. The I/O engine 104 is coupled to the scalable fabric 102 so that the I/O engine 104 can communicate with other entities in the processing system 100 by exchanging signals over the scalable fabric 102.

Processing system 100 also includes or has access to a memory 106 or other storage component implemented using a non-transitory computer-readable medium such as a dynamic random-access memory (DRAM). However, some embodiments of the memory 106 are implemented using other types of memory including, for example, static random-access memory (SRAM), nonvolatile RAM, and the like. Some embodiments of the memory 106 include an external memory implemented external to the processing units implemented in the processing system 100. The memory 106 can store information representing instructions such as program code 108 for one or more applications (e.g., graphics applications, compute applications, ML models or applications), data 110 that is consumed by the program code 108, and results 112 produced by executing the program code 108.

One or more central processing units (CPUs) 114 are deployed in the processing system 100, although only one CPU 114 is indicated by a reference numeral in the interest of clarity. The CPU 114 is connected to the scalable fabric 102 to communicate with other entities in the processing system 100, such as the I/O engine 104, the memory 106, or other entities connected to the scalable fabric 102. The CPU 114 includes circuitry configured to implement a plurality of processor cores 116-1, 116-2, . . . 116-M that execute instructions concurrently or in parallel. Although three processor cores 116 are shown in FIG. 1, more or fewer processor cores 116 can be implemented in other embodiments of the CPU 114. The processor cores 116 include circuitry to implement one or more compute units such as single-instruction, multiple data (SIMD) units that perform the same operation on different data sets to produce one or more results. The CPU 114 is configured to execute instructions such as the program code 108 for one or more applications (e.g., graphics applications, compute applications, machine learning applications), which is stored in the memory 106. The CPU 114 can consume data 110 and store information in the memory 106 such as the results 112 of the executed instructions.

The processing system 100 also includes one or more parallel processors 118, although only one parallel processor 118 is indicated by a reference numeral in the interest of clarity. The parallel processors 118 can include, for example, a GPU, a general-purpose GPU (GPGPU), a neural processing unit (NPU), a tensor processing unit (TPU), an intelligence processing unit (IPU) or other vector processor or type of parallel processor. The parallel processors 118 include circuitry to implement one or more processor cores 120-1 . . . N that each operate as a compute unit configured to perform one or more operations based on one or more instructions received by the parallel processors 118. Although three processor cores 120 are shown in FIG. 1, more or fewer processor cores 120 can be implemented in other embodiments of the parallel processor 118. The compute units in the processor cores 120 are implemented as circuitry for one or more single-instruction, multiple data (SIMD) units that perform the same operation on different data sets to produce one or more results.

In the illustrated embodiment, the parallel processors 118 include circuitry for storing data such as one or more high bandwidth memories (HBM) 122 that are used to store instructions or data that are accessed by one or more of the processor cores 120 via high bandwidth connections (not shown in FIG. 1 in the interest of clarity). Some embodiments of the HBM 122 store instructions or information that has been retrieved or fetched from memory 106. For example, instructions can be fetched from the program code 108 and stored in HBM 122; data can be fetched from the data 110 and stored in the HBM 122. Although the HBM 122 is shown internal to the parallel processors 118 and external to the processor cores 120, some embodiments of the processor cores 120 include additional, internal HBM or caches and some embodiments of the HBM 122 are implemented external to the parallel processors 118.

Switch 101 interconnects the parallel processors 118 so that information can be conveyed between the parallel processors 118 via the switch 101. In the illustrated embodiment, the switch 101 includes circuitry configured to operate as a crossbar switch. However, circuitry in other embodiments of the switch can be configured to operate as a network interface card (NIC), smart NIC, or other type of network switch. The switch 101 includes memory and processing resources such as one or more compute units (not shown in FIG. 1 in the interest of clarity). The memory in the switch 101 stores information such as information representing adapter matrices that are applied to the base matrices of a generative AI model, as discussed herein. The compute units perform operations including matrix multiplication on one or more of the adapter matrices the base matrices, and input matrices to the generative AI model, as discussed herein.

The processing system 100 is configured to train an ML model or perform inference on the trained ML model based on input vectors of matrices. In some embodiments, the ML model is a generative AI model that is represented (at least in part) by a base matrix including information representing weights and activation functions of layers in the generative AI model. In the illustrated embodiment, the parallel processors 118 are configured to generate a first matrix by performing matrix multiplications on portions of the base matrix and corresponding portions of an input matrix provided to the generative AI model. For example, individual ones of the parallel processors 118 can be configured to perform matrix multiplications on different shards of the base matrix and the input matrix to form corresponding shards of the first matrix. The individual ones of the parallel processors 118 provide copies of the portions of the input matrix and the first matrix to the switch 101. The compute unit in the switch 101 performs matrix multiplications of a subset of the adapter matrices and the portions of the input matrix to form a second matrix. As discussed herein, the adapter matrices can include first and second adapter matrices. Depending on the size of the memory associated with the switch 101, the available processing resources of the switch 101, or a combination thereof, the subset of adapter matrices can include both the first and second adapter matrices or only the second adapter matrix. In response to completing the matrix multiplications, the compute unit in the switch 101 combines the portions of the first matrix and the second matrix to form a third matrix that is distributed to the parallel processors 118.

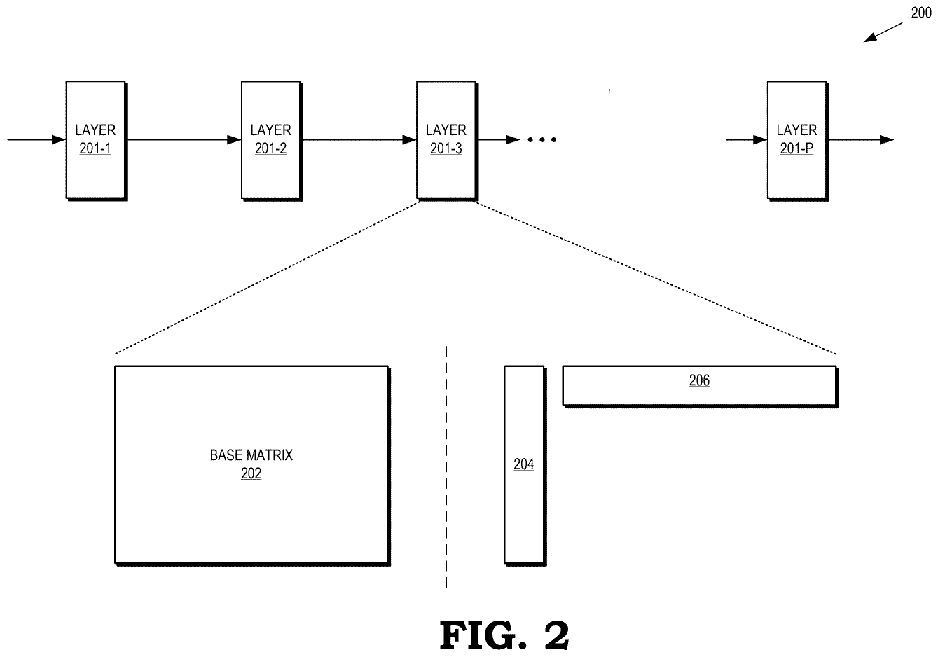

FIG. 2 illustrates a generative AI model 200 formed of a series of layers 201, according to some embodiments. The illustrated embodiment of the generative AI model 200 includes P layers 201, which can include attention layers, transformer layers, feed forward layers, pooling layers, and the like. The layers 201 are represented by weight matrices, which can be fine-tuned using one or more adapter matrices. In the illustrated embodiment, the layer 201-3 is represented by a base matrix 202 of a generative AI model and adapter matrices 204, 206 that are used to fine-tune the generative AI model, according to some embodiments. Although not shown in FIG. 2 in the interest of clarity, one or more of the remaining layers 201 can be represented by other base matrices and adapter matrices. Some embodiments of the processing system 100 shown in FIG. 1 are configured to train, fine-tune, or perform inference using base matrix 202 that represents the generative AI model and the adapter matrices 204, 206 that represent domain-specific data, data associated with individual contexts, and the like.

The base matrix 202 can be represented as a weight matrix W having dimensions h×k and the adapter matrices 204, 206 can be represented as a first adapter matrix A having dimensions h×r and a second adapter matrix B having dimensions r×k. The sizes of the adapter matrices 204, 206 are chosen so that r«min (h, k). For example, if the base matrix represents values of parameters of a large generative AI model, h and k can be on the order of 10³ or 10⁴. In contrast, the sizes of the adapter matrices 204, 206 are orders of magnitude smaller, e.g., r<10. In some embodiments, such as those used to implement low rank adaptation (LoRA), the first adapter matrix 202 is initialized using Kaiming-uniform initialization, random Gaussian data, orthonormal matrix initialization, and the like. The second adapter matrix 204 is initialized to zero. The base matrix 202 is typically trained prior to training the adapter matrices 204, 206. The base matrix can then be frozen (and non-trainable) and the adapter matrices 204, 206 are trainable. During the training process, the output of the layer is calculated as x(W+AB), where x is an input matrix having dimensions n×h. This fine-tuning approach is efficient because the adapter matrices 204, 206 are very small relative to the base matrix 202. Consequently, the processing system only calculates gradients and updates a small fraction of all the weights in the model.

In response to completing model fine-tuning, e.g., via low rank adaptation, the adapter matrices 204, 206 are merged into the base model 200 to create a new, updated or modified, weight matrix W′=(W+AB), which is used for serving during inference execution. For example, as part of a forward pass during inference, the input x is multiplied with the new weight matrix W′. There is no additional latency (relative to performing inference using the base model 200) because once the fine-tuning is complete, the adapter matrices 204, 206 are merged into the original weight matrix W of the base model 200. However, the conventional approach of merging the adapter matrices 204, 206 into the base model 200 requires that the adapted model only serves one use case (corresponding to one version of the adapter matrices 204, 206). If multiple adapted models are generated to serve different use cases, the system is required to store separate (and very large) weight matrices W′ to serve different use cases.

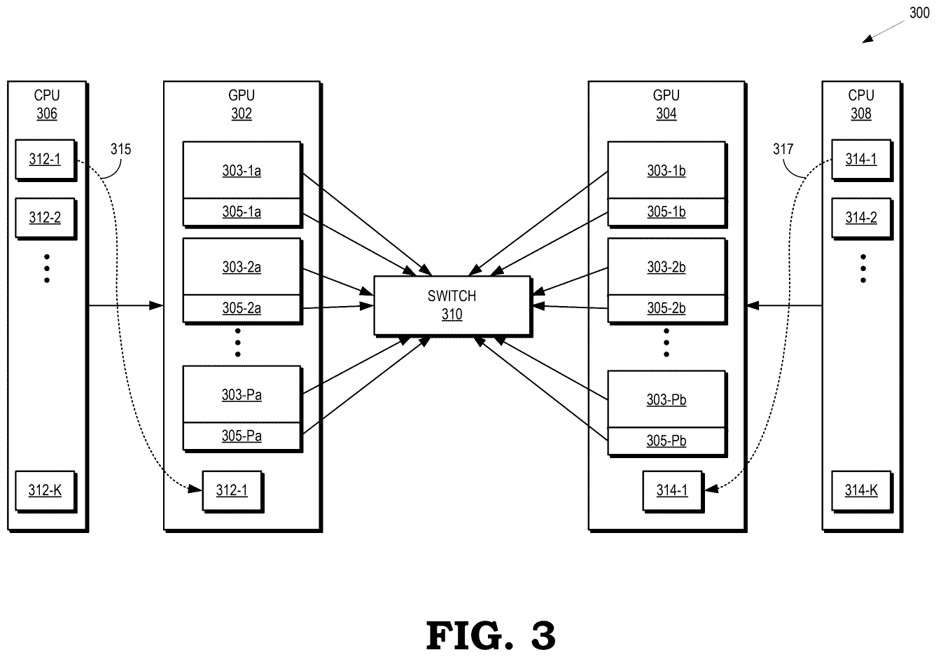

FIG. 3 illustrates a processing system 300 that supports multi-tenant training and inference for fine-tuned generative AI models, according to some embodiments. The processing system includes GPUs 302, 304 and associated CPUs 306, 308. The GPUs 302, 304 are interconnected by a switch 310 such as a crossbar switch. The switch 310 is relatively “dumb,” and does not include memory or significant processing resources. Although two GPUs 302, 304 are shown in FIG. 3 in the interest of clarity, additional GPUs are implemented in some embodiments of the processing system 300. In the illustrated embodiment, a generative AI model has P layers at are represented by corresponding weight matrices and, in some cases, adapter matrices. For example, the generative AI model can be represented by 32 layers, 64 layers, or other numbers of layers. The (fine-tuned, in some cases) weight matrices are applied in serial to an input vector x to produce output. FIG. 3 illustrates operation of the processing system 300 on one of the P layers.

The fine-tuned models that represent different layers have different sets of adapter matrices (Aᵢ, Bᵢ), where 0≤i<P. Merging the fine-tuned models with the base model and then storing the modified, fine-tuned base model requires storing P different weight matrices W'i instead of storing a single copy of the base weight matrix W and P copies of the adapter matrices (Aᵢ, Bᵢ). The processing system 300 therefore processes the adapter weight matrices (Aᵢ, Bᵢ) separate from processing the base weight matrix W. For example, during a forward pass, the GPUs 302, 304 compute xW and xAᵢBᵢ separately and then add the resulting matrices together. In the illustrated embodiment, the xW matrices for the fine-tuned models are represented as the boxes 303-1, 303-2, . . . , 303-P and the xAᵢBᵢ matrices are represented as the boxes 305-1, 305-2, . . . , 305-P. As discussed herein, the GPUs 302, 304 operate on different portions (or shards) of the matrices 303, 305. For example, the GPU 302 operates on the portions 303-1a, 305-1a and the GPU 304 operates on the portions 303-1b, 305-1b. This separation preserves the original model weights and thus reduces the memory required to serve multiple fine-tuned models derived from the same base weight matrix W. The additional compute overhead required to perform inference can be acceptable because the GPUs 302, 304 are typically bottlenecked by memory or communication bandwidth.

The number of fine-tuned models that can be served by the processing system 300 is limited by the memory capacity available to hold the low rank adapter weight matrices (Aᵢ, Bᵢ). The HBM available in the GPUs 302, 304 is relatively small so the low rank adapter weight matrices (Aᵢ, Bᵢ) are stored in the memory of the associated CPUs 306, 308. In the illustrated embodiment, the CPU 306 stores information representing low rank adapter matrices 312-1, 312-2, . . . , 312-K and the CPU 308 stores information representing low rank adapter matrices 314-1, 314-2, . . . , 314-K. The CPUs 306, 308 can then provide the low rank adapter matrices 312, 314 to the corresponding GPUs 302, 304 on demand, e.g., in response to requests from the GPUs 302, 304, as indicated by the arrows 315, 317. This approach mitigates the constraints imposed by the capacity of the HBM but introduces a new constraint caused by limited bandwidth between the GPUs 302, 304 and the CPUs 306, 308, at least in part because this link is already utilized for copying inputs/outputs of the models, loading key-value (KV) caches for attention-based models, and the like. Using this link to swap in the adapter matrices 312, 314 increases bandwidth contention for the finite resources of the link.

In the illustrated embodiment, the base model and the adapter matrices are sharded into N shards that are distributed across the GPUs 302, 304 so that each of the GPUs 302, 304 stores and operates on submatrices:
Wⱼ of size (h, k/N), where j is the index of the shard
Aⱼ of size (h, r/N), and
Bⱼ of size (r/N, k)
   The forward pass through the model performed in each of the GPUs 302, 304 is therefore:
multiply shard of base model weights Wⱼ with the input matrix x to get xWⱼ, which has dimensions (n, k/N)
multiply input matrix x with Aⱼ to get xAⱼ
multiply xAⱼ with Bⱼ to get the partial matrix xAⱼBⱼ, which has dimensions (n, k)
combine the shards xWⱼ across the GPUs 302, 304 (e.g., using the AllGather command) to get xW, which has dimensions (n, k)
combine the partial matrices xAⱼBⱼ from across the GPUs 302, 304 (e.g., using the AllReduce command) to get xAB, which has dimensions (n, k)
combine or add xW and xAB to get x(W+AB)
   Aggregating the various movements of data between the GPUs 302, 304 and the CPUs 306, 308, the total number of elements that are transferred over the network is:

D₀=(N−1)*n*k+2*(N−1)*n*k=3*(N−1)*n*k

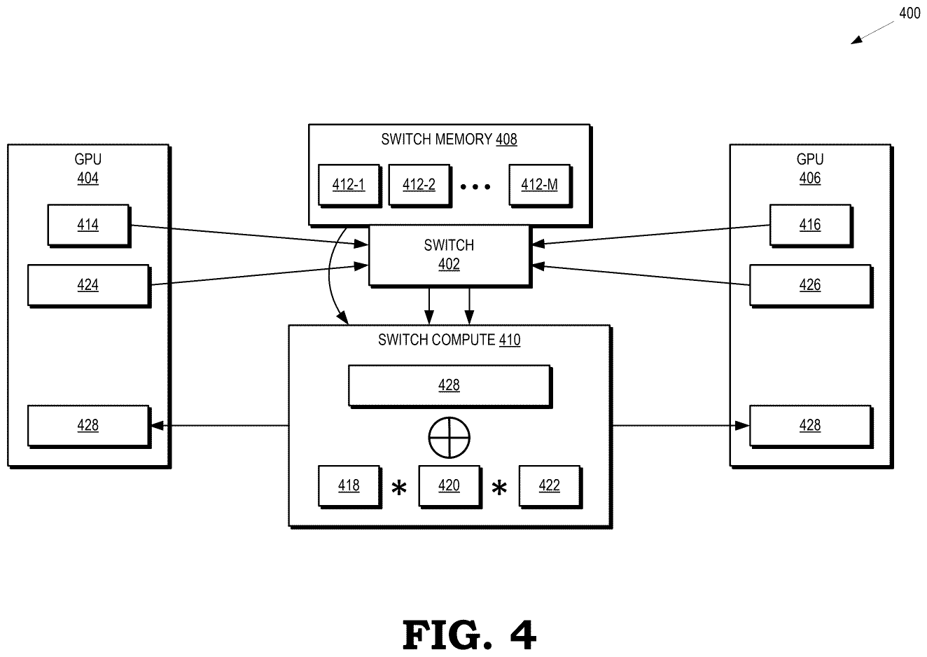

FIG. 4 illustrates a processing system 400 that supports multi-tenant training and inference for fine-tuned generative AI models by offloading processing of adapter matrices to a “smart” switch 402, according to some embodiments. The processing system includes GPUs 404, 406 that are interconnected by the switch 402, which includes (or is associated with) a switch memory 408 and computing resources 410. Although not shown in FIG. 4 in the interest of clarity, the GPUs 404, 406 also include GPU computing and GPU memory resources such as the processor cores 120 and the HBM 122 shown in FIG. 1. In the illustrated embodiment, the processing system 400 is operating on one layer of a multi-layer generative AI model.

In the illustrated embodiment, the A and B adapter matrices 412-1, 412-2, . . . , 412-P are stored in the switch memory 408 instead of being stored in the associated CPU (not shown in FIG. 4 in the interest of clarity). The compute resources 410 access the adapter matrices 412 via the switch 402. Portions, or shards, of the base model weights Wⱼ and the input matrix xᵢ are distributed among the GPUs 404, 406. For example, the base model weight W₁ and the input matrix x₁ (414) are provided to, and stored on, the GPU 404. The base model weights W₂ and the input matrix x₂ (416) are provided to, and stored on, the GPU 406. The compute resources 410 access the base model weights and the input matrices 414, 416 via the switch 402.

A forward pass through the fine-tuned model is performed with full adapter compute offload as follows:
Each of the GPUs 404, 406 moves a copy of its shard of the input matrix xᵢ (414, 416) to the switch 402, which gathers the information to form the input matrix x (418). Moving this information results in n*k/N elements of data being moved per-GPU. In some embodiments, the GPUs 404, 406 initiate, start, or begin computing xWⱼ concurrently or in parallel with operations performed by the compute resources 410, as discussed herein.
A switch 402 fetches the A and B adapter matrices 420, 422, which are not sharded in the illustrated embodiment. The compute resources 410 compute xAB concurrently with the GPUs 404, 406 computing xWⱼ (424, 426) for their corresponding shards.
The GPUs 404, 406 then provide compute output shards 424, 426 to the compute resources 410 via the switch 402. The size of each output shard 424, 426 is n*k/N and the compute resources 410 combine xW and xAB to form the output x(W+AB) (428). Copies of the resulting matrix 428 are then distributed to the GPUs 404, 406. Transfer of the matrix 428 requires moving n*k elements to each of the GPUs 404, 406 via the switch 402.
   Aggregating the various movements of data between the switch 402 and the GPUs 404, 406, the total number of elements that are transferred over the network is:

D₁=N*(n*h/N+n*k/N+n*k)=(N+1)*n*k+n*h

Consequently, the amount of data that is transferred over the network in the processing system 400 is significantly less than the amount of data that is transferred in the processing system 300 shown in FIG. 3, i.e., D₁«D₀.

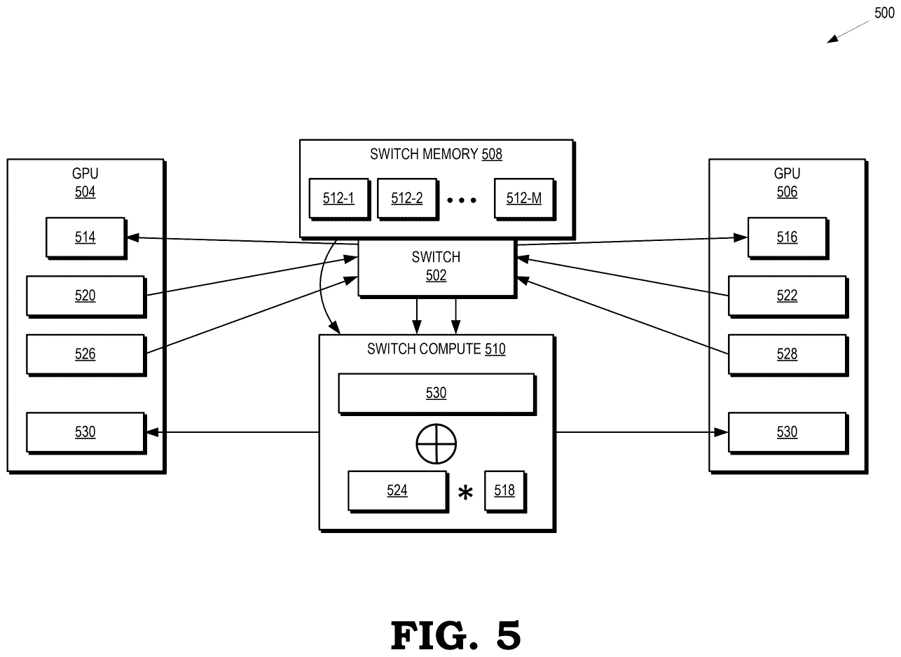

FIG. 5 illustrates a processing system 500 that supports multi-tenant training and inference for fine-tuned generative AI models by partially offloading processing of adapter matrices to a switch 502, according to some embodiments. The processing system includes GPUs 504, 506 that are interconnected by the switch 502, which includes (or is associated with) a switch memory 508 and computing resources 510. Although not shown in FIG. 4 in the interest of clarity, the GPUs 404, 406 also include GPU computing and GPU memory resources such as the processor cores 120 and the HBM 122 shown in FIG. 1. In the illustrated embodiment, the processing system 500 is operating on one layer of a multi-layer generative AI model.

In the illustrated embodiment, the A and B adapter matrices 512-1, 512-2, . . . , 512-P are stored in the switch memory 508. However, the compute resources 510 are not sufficient to perform the matrix multiplications on the adapter matrices 512, at least not fast enough to complete the matrix multiplications concurrently with the matrix multiplications of the base matrix performed in the GPUs 504, 506. Thus, matrix multiplications on the adapter matrices 512 are divided between the compute resources 510 and the GPUs 504, 506. In some embodiments, partial offloading of matrix multiplications to the compute resources 510 is performed based on the availability of the compute resources 510. For example, partial offloading is performed if the compute resources 510 are below a threshold for completing the matrix multiplications within a predetermined time interval.

In the illustrated embodiment, shards 514, 516 of the A adapter matrices are conveyed to the GPUs 504, 560 via the switch 502. The compute resources 510 access the B adapter matrices 518 via the switch 502. Portions, or shards, of the base model weights Wⱼ and the input matrix xᵢ are distributed among the GPUs 404, 406. For example, the base model weight W₁ and the input matrix x₁ are provided to, and stored on, the GPU 504. The base model weights W₂ and the input matrix x₂ are provided to, and stored on, the GPU 506.

A forward pass through the fine-tuned model is performed with partial adapter compute offload as follows:
The switch 502 fetches the A adapter matrix from a memory 508 and then conveys shards Aⱼ of the A adapter matrix to the GPUs 504, 506. Each transfer of a shard conveys h*r/N elements.
Each of the GPUs 504, 506 multiplies the input matrix x by its corresponding shard Aj to form the matrix xAⱼ (520, 522) and then conveys the matrices 520, 522 to the switch 502. Each transfer of one of the matrices 520, 522 conveys n*r/N elements.
The switch 502 combines the matrices xAⱼ to form the matrix xA (524), which is provided to the compute resources 510. The compute resources 510 multiply the matrix xA (524) and the portion of the adapter matrix B (518) to form the matrix xAB.
Concurrently with operations performed by the switch 502, the GPUs 504, 506 compute xWⱼ (526 , 528).
In response to completing their operations, the GPUs 504, 506 move their computed matrices xWⱼ (526, 528) to the switch 502, which combines them to produce the matrix xW.
The compute resources 510 combine xW and xAB to form the output x(W+AB) (530). Copies of the resulting matrix 530 are distributed to the GPUs 504, 506. Transfer of the matrix 530 requires moving n*k elements to each of the GPUs 504, 506 via the switch 502.
   Aggregating the various movements of data between the switch 502 and the GPUs 504, 506, the total number of elements that are transferred over the network is:

D₂=N*(h*r/N+n*r/N+n*k/N+n*k)=(N+1)*n*k+r*(n+h)

Consequently, the amount of data that is transferred by the processing system 500 is significantly less than the amount of data that is transferred by the processing system 300 shown in FIG. 3, i.e., D₂«D₀.

In some embodiments, certain aspects of the techniques described above are implemented by one or more processors of a processing system executing software. The software includes one or more sets of executable instructions stored or otherwise tangibly embodied on a non-transitory computer readable storage medium. The software can include instructions and data that, when executed by one or more processors, manipulate the processor(s) to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus comprising:
a plurality of parallel processors configured to perform matrix multiplications on portions of a base matrix of a generative artificial intelligence (AI) model and corresponding portions of an input matrix to form portions of a first matrix; and
a switch configured to receive a copy of each portion of the input matrix and each portion of the first matrix from the plurality of parallel processors, perform matrix multiplications of a subset of a plurality of adapter matrices and the portions of the input matrix to form a second matrix, combine the portions of the first matrix and the second matrix to form a third matrix, and distribute one or more copies of the third matrix to the plurality of parallel processors.

2. The apparatus of claim 1, wherein a plurality of adapter matrices comprises a first adapter matrix and a second adapter matrix.

3. The apparatus of claim 2, wherein the subset of the plurality of adapter matrices comprises the first adapter matrix and the second adapter matrix, and wherein the switch is configured to perform matrix multiplications of the input matrix, the first adapter matrix, and the second adapter matrix to form the second matrix.

4. The apparatus of claim 2, wherein the subset of the plurality of adapter matrices comprises the second adapter matrix, and wherein the switch is configured to perform matrix multiplications of the input matrix and the second adapter matrix to form the second matrix.

5. The apparatus of claim 4, wherein the plurality of parallel processors is configured to perform matrix multiplications on the portions of the input matrix and corresponding portions of the first adapter matrix to form a fourth matrix, wherein the plurality of parallel processors is configured to provide the fourth matrix to the switch.

6. The apparatus of claim 5, wherein the switch is configured to combine the portions of the first matrix, the second matrix, and the fourth matrix to form the third matrix.

7. The apparatus of claim 1, wherein the plurality of parallel processors and the switch are configured to perform matrix multiplications concurrently or in parallel.

8. The apparatus of claim 1, wherein the plurality of adapter matrices represents domain-specific knowledge or knowledge of an individual context that is used to fine-tune the generative AI model.

9. The apparatus of claim 8, wherein the plurality of parallel processors is configured to modify the generative AI model based on the third matrix, and wherein the plurality of parallel processors is configured to infer new data based on the modified generative AI model.

10. A method comprising:
performing, at a plurality of parallel processors, matrix multiplications on portions of a base matrix of a generative artificial intelligence (AI) model and corresponding portions of an input matrix to form portions of a first matrix;
providing, from the plurality of parallel processors to a switch, a copy of each portion of the input matrix and each portion of the first matrix;
performing, at the switch, matrix multiplications of a subset of a plurality of adapter matrices and the portions of the input matrix to form a second matrix;
combining, at the switch, the portions of the first matrix and the second matrix to form a third matrix; and
distributing from the switch to the plurality of parallel processors, copies of the third matrix.

11. The method of claim 10, wherein a plurality of adapter matrices comprises a first adapter matrix and a second adapter matrix.

12. The method of claim 11, wherein performing the matrix multiplications at the switch comprises performing, at the switch, matrix multiplications of the input matrix, the first adapter matrix, and the second adapter matrix to form the second matrix.

13. The method of claim 11, wherein performing the matrix multiplications at the switch comprises performing, at the switch, matrix multiplications of the input matrix and the second adapter matrix to form the second matrix.

14. The method of claim 13, wherein performing the matrix multiplications at the plurality of parallel processors comprises performing, at the plurality of parallel processors, matrix multiplications on the portions of the input matrix and corresponding portions of the first adapter matrix to form a fourth matrix, and further comprising:
providing the fourth matrix from the plurality of parallel processors to the switch.

15. The method of claim 14, further comprising:
combining, at the switch, the portions of the first matrix, the second matrix, and the fourth matrix to form the third matrix.

16. The method of claim 10, further comprising:
concurrently performing matrix multiplications at the plurality of parallel processors and the switch.

17. The method of claim 10, wherein the plurality of adapter matrices represents domain-specific knowledge or knowledge of an individual context that is used to fine-tune the generative AI model, and further comprising:
modifying the generative AI model based on the third matrix.

18. The method of claim 17, further comprising:
inferring new data based on the modified generative AI model.

19. An apparatus comprising:
a switch comprising a memory and at least one compute unit, wherein:
the memory is configured to store a plurality of adapter matrices or updating a base matrix of a generative artificial intelligence (AI) model; and
the at least one compute unit is configured to form a first matrix by performing matrix multiplications of a subset of the plurality of adapter matrices and corresponding portions of an input matrix received from a plurality of parallel processors and form a second matrix by combining the first matrix and a third matrix generated by matrix multiplications of the base matrix and the input matrix performed by the plurality of parallel processors, and
wherein the apparatus is configured to distribute copies of the second matrix to the plurality of parallel processors.

20. The apparatus of claim 19, wherein the compute unit is configured to perform matrix multiplications concurrently or in parallel with the plurality of parallel processors performing matrix multiplications.
